(19) United States
(12) Patent Application Publication
(10) Pub. No.: US 2004/0148250 A1
(43) Pub. Date: Jul. 29, 2004

(54) System and method for trading in stock-exchange securities via telematics with accelerated organization

(76) Inventor: Mario Fabbri, Torino (IT)

Correspondence Address: MERCHANT & GOULD PC, P.O. BOX 2903, MINNEAPOLIS, MN, 55402-0903, US

(21) Appl. No.: 10/479,481

(22) PCT Filed: May 2, 2002
(86) PCT No.: PCT/EP02/04819

(30) Foreign Application Priority Data
Jun. 22, 2001 (IT) TO2001A000603

(51) Int. Cl. G06F 17/60

(52) U.S. Cl. 705/37

(57) ABSTRACT

A system for entering and sending orders for buying and selling stock-exchange securities via telematics with accelerated organization, according to which, by means of a graphic interface of the type commonly used on personal computers equipped with keyboard and/or mouse and/or pen and/or other device for interacting with the screen, it is possible to pre-enter a set of parameters for the securities in question, such as the security (22) itself, the limit price (24) of the order, the amount desired (25), and the type of buying or selling transaction (27, 28); the amounts (25) may be entered for each security (22) when making the first order, and then remain valid for the subsequent orders, the same applying as regards the price (24), for which, where it is not typed in explicitly as a constant datum, it is possible to use a symbolic parameter which determines it dynamically by the flow of the prices of the said security which arrive from the market at the instant in which the order is sent. To send the transaction order to the market, for all orders after the first, it is sufficient to click on the buy key (27) or sell key (28) of the screen (20), without having to waste time entering the new parameters of the order.

The present invention relates to a system for entering and sending orders for buying and selling stock-exchange securities via telematics with accelerated organization.

More in particular, the invention describes a methodology for sending, by electronic and telematic means, transactions for the buying and selling of securities quoted on any telematic stock market.

Even more specifically, the invention regards a particular application software by means of which the user is able to carry out, at an extremely high speed, sending of an enormous amount of orders for buying and selling stock-exchange securities.

For many years now, trading in securities quoted on the stock market has been carried out by means of brokers who are physically present on a given financial market and who perform buying and selling operations according to written orders of clients and confirm the transactions concluded, possibly by markings or paper receipts.

More recently, financial transactions have been automated, and the orders for buying and selling securities can be sent by the investors, who are clients and are connected, normally via the Internet, to any on-line broker directly by a personal computer, in such a way that a pre-defined sequence of keys or clicks will compose the procedures necessary for determining completely and notifying the purchasing or selling order to the system of the broker, who, in turn, is able to transmit the order to the telematic stock markets.

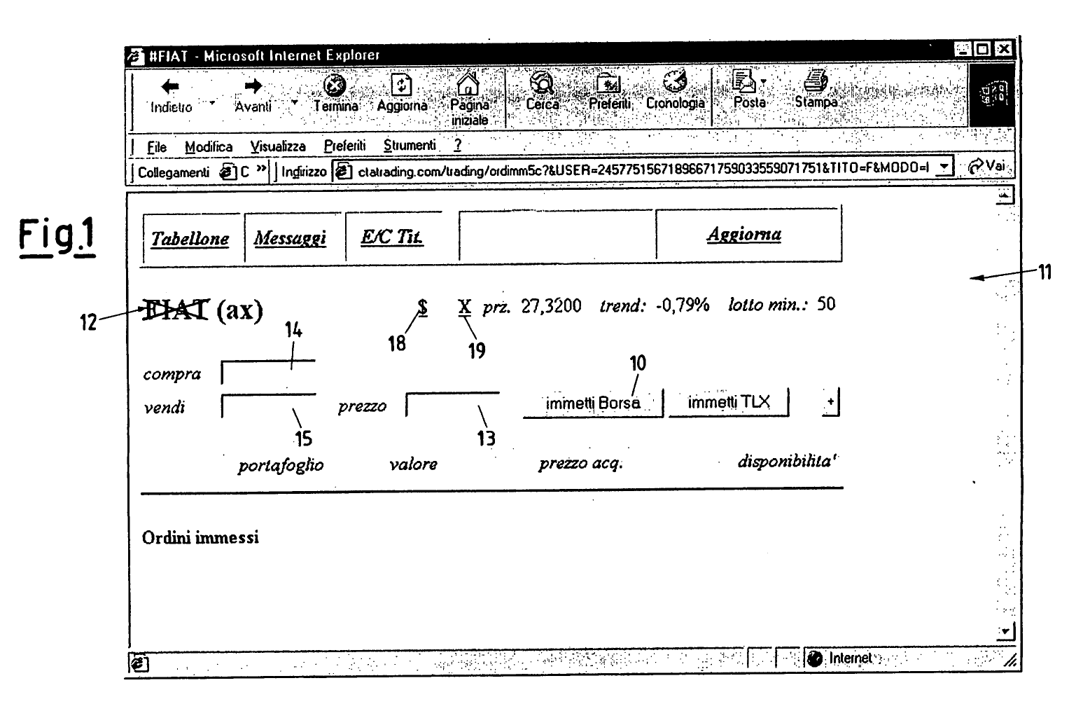

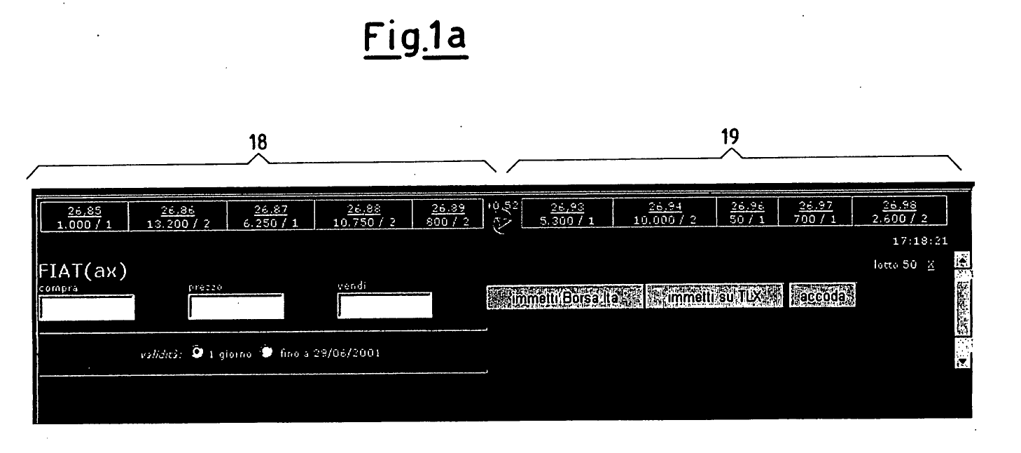

Normally, the above on-line trading systems envisage that the investor will fill in a form directly on the monitor of the personal computer, the said form, in the majority of cases, assuming an appearance like the one represented in the diagram of FIG. 1.

By pressing a predetermined key, such as the “Enter Market” key designated by 10 in FIG. 1 or a similar key, it is possible to transmit a trading order, which, following upon the routine cross checks required (regarding, in the first place, the availability of funds or securities of the client, for purchasing and selling orders, respectively), is forwarded to an on-line broker who can be reached telematically, and then to the market.

The parameters that are absolutely necessary for a complete definition of an order for purchasing or selling a stock-exchange security, according to the form presented on the screen 11 appearing in FIG. 1, number in all four and refer to a code 12 of the security requested, to the quantity, to the limit price 13, and to the choice between buying 14 or selling 15.

In particular cases, there may exist the possibility of entering further detailed parameters that can be recognized and accepted by the telematic market on which the order is to be sent, such parameters specifying, in greater detail, the type of order: for example, “execute to date”(for orders which, if not executed, remain valid for a number of days), “execute to time”(for orders that are valid up to a time limit), “all or nothing”(when partial executions are not accepted), etc.

In order to simplify and expedite the supply of the parameters of this type of orders, there have for some time been available, in telematic systems, a number of minor facilities, such as the possibility of choosing the first of the above four parameters, namely the security code, from a list, or that of being able to indicate, in the “price parameter” box, the purchase of the security “at market price”—and namely, in the case of selling, at the price of the best purchasing proposal at the current instant (this price being referred to as “money”) and, in the case of buying, at the price of the best selling proposal (this price being referred to as “letter”).

However, the above procedure of preparation of the order as illustrated in the screen 11 (FIG. 1) of the personal computer proves adequate only when the number of the orders sent by the investor is relatively limited, or else the said orders are very far apart from one another in time, or when the variability between the parameters of one order and another, as these are prepared, is very great.

In fact, in these cases, there is an unavoidable need to take time during typing-in of the values corresponding to the securities in question, in each of the specific boxes, and hence it is possible that it will be necessary to face the considerable, but inevitable, complication of having to fill in the items before the order can be considered complete and ready for being sent to the broker. A number of means for speeding up the above organization have, for some time now, been devised in order to reduce the time required for preparing the parameters of the order, thus rendering the forwarding of the order simpler and faster, this constituting a particularly important factor in a sector such as that of real-time operativeness on financial markets, where an edge of a fraction of a second over an offer made by another investor may lead to considerable economic returns.

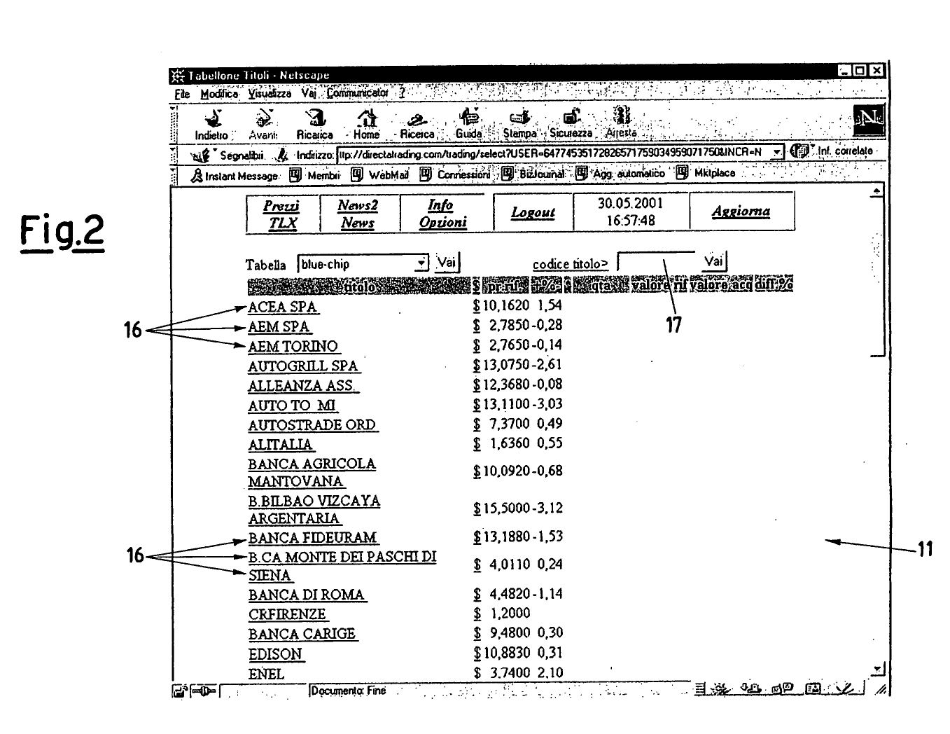

For instance, if it is taken into account that habitual investors typically operate on a restricted number of securities, the information system may provide for the presence of one or more lists of preferred securities, such as the one illustrated in the example of FIG. 2.

In this case, it is sufficient to click on any one of the names of the securities 16 to enable a form for entering the order to come up on the screen.

The security code 12 (see FIG. 1) is already pre-set, and there remains only to enter the parameters for the amount and price. In the specific case of FIG. 1, in order to achieve an additional and corresponding speeding-up of operations, the choice between purchasing and selling is defined, instead of by introducing an explicit and special parameter, by selecting the box (“buy” or “sell”), in which the desired amount is then entered.

In actual fact, it is normal to use a single box for the amount and to specify the parameter (“buy” or “sell”) in a particular area specially provided for this purpose.

A further acceleration is possible when the user starts from a real-time price-list.

By clicking on one of the prices shown as being present on the market in real time, the order form is automatically pre-set for the corresponding security, the price clicked upon already being assumed as the price parameter.

As a further user aid, in this case illustrated in FIG. 1a, according to whether the aforesaid price is clicked upon on the “money” side (link 18) or on the “letter” side (link 19), the sale order or purchasing order is automatically pre-set by positioning the cursor on the appropriate box in which the datum regarding the amount is to be typed in.

The delaying element for the above procedures is normally represented, however, by the need to specify, each time, the amount, and the preparation of the order is an activity that calls for explicit entry of at least one parameter, before forwarding of the order to the on-line broker is possible.

A purpose of the present invention is therefore to overcome as far as possible the drawbacks mentioned above, and in particular to provide a system for entering the parameters of an order for the trading of stock-exchange securities which, in the case of repeated orders for a security, will reduce to an absolute minimum (possibly to a single click) the time required for sending the order to the broker.

A further purpose of the present invention is to maintain a clear and immediate understanding of the characteristics of the order that is being sent, so that the increased speed will be effectively usable without any misgivings.

Yet a further purpose of the invention is to provide a system for entering the parameters of financial trading orders which will make it possible to speed up sending of multiple orders in close succession on more than one security, reducing the work required of the investor normally to “one click per security”.

The above purposes are achieved by a system for buying and selling stock-exchange securities via telematics with accelerated organization, in accordance with Claim 1, and by a corresponding method according to Claim 8, to which the reader is referred for reasons of brevity.

The desired results are fully achievable, in particular, as far as or as long as the trading operations are carried out and repeated on a well-defined number of securities, and the investor normally uses, for each security, a specific purchasing and selling lot. This is what, in effect, usually occurs in the so called “scalping” technique, according to which, let us suppose, an investor first purchases 100 pieces of the security A, and a few seconds or a few minutes later resells them, even upon a very tenuous rise, in order to obtain a sure gain on the small difference. Alternatively, where the investor could operate short of stock, he could also first sell, let us assume, again 100 pieces, and later, after a drop in price, cover himself again with a purchase once more of 100 pieces, also in this case making a gain.

In particular, in cases of this sort, it becomes advantageous to have the order form prepared on the screen of the personal computer, where, in addition to the code of the security in question, also the amount between one order and the next can remain stabilized, leaving as potential variable the sale price, which, on the other hand, is not necessarily a parameter that needs to be entered manually.

In fact, the variable price could be linked to the current market price (which, in order-management systems in many automated markets, is the so called “market-price order”, which can be specified with a purposely designed symbolic-price parameter), or else could remain determined, at the moment of sending of the order, by the “money price” or “letter price”, which are visible to the investor as arriving in real time from the market.

The latter possibility ought, in theory, to be identical to the previous one, but is preferred to the previous one by many expert investors, owing to the fear of a sudden unfavourable change in prices with respect to the securities visible as coming in real time from the market in the interval in which the “market price” order is reaching the market. The limit price of the order could finally be defined in a still more refined way as being “set at N ticks distance from the money and letter prices”(the tick is the minimum price interval accepted by the telematic market). In the case of large orders, in order to have a complete execution thereof it may in fact be necessary (let us suppose in the case of purchase of a security) not to limit oneself to accepting just the best sale offer currently present on the market, because the amount on sale at that price might not be sufficient to cover the entire order.

If, then, we indicate as limit price in the order a price that is higher than the letter price (for instance, “I will buy up to 3 ticks above letter”, which for a sale would become: “I will sell up to 3 ticks under money”), once the amounts present on sale at letter price were to be insufficient to exhaust the order, the investor would pass directly to acquiring securities also from selling proposals present on the market, but at a higher price level.

Thanks to these artifices, the variable price would be entered explicitly only in anomalous cases, in which an immediate execution is not expected and in which the loss of time for filling in the order is thus not of particular importance.

Further purposes and advantages of the present invention will emerge clearly from the ensuing description and from the attached drawings, which are provided purely by way of explanatory, non-limiting example of embodiment, and in which:

FIG. 1 represents a screen of a personal computer for a form to be filled in for executing a transactional order in systems for on-line trading of stock-exchange securities of a traditional type;

FIG. 1a represents a screen for introducing an order for a predetermined security with integrated market quotations;

FIG. 2 represents a screen of a personal computer for a list of “favourite” securities, which is designed for recalling, with a single click on the selected security, a screen for entering an order for a security, of the type illustrated in FIG. 1 or FIG. 1a; and

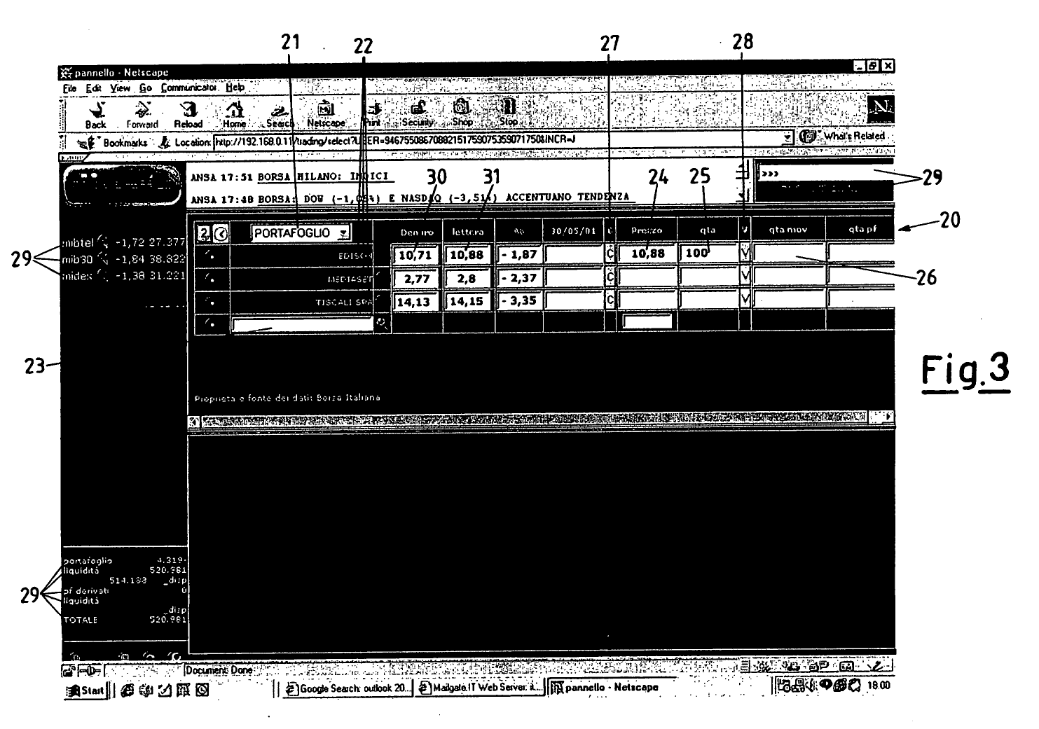

FIGS. 3, 4 and 5 refer to a series of screens for transactional-order purchasing forms for on-line security-trading systems with accelerated organization, in accordance with the present invention.

With particular reference to FIGS. 3 to 5, the trading system which forms the subject of the invention is connected to a remote computer system (not illustrated in the figures), which performs two distinct functions: information and trading; that is, on the one hand, real-time diffusion to the investors of the data on current market prices, and, on the other hand, the receipt, control and forwarding of the trading orders to the markets.

In this way, from their individual workstations, the investors can keep an eye on the most significant stock-market data appearing on the screen 20 of the personal computer and can enter, via keyboard and/or mouse and/or pen and/or some other device for interacting with the screen, the information necessary and the corresponding instructions for telematic trading on a given lot 21 of stock-exchange securities made up of a set of pre-chosen securities 22.

The figures mentioned above illustrate the improvement as regards accelerated organization of entry and sending of trading orders according to the invention, which comprises a graphic interface designed for connection with the broker's system.

Whereas previously the data necessary for a financial transaction (security, quantity, price, buying/selling) had to be typed in on the keyboard of the personal computer and shown on the screen 11 before the order could be transmitted to the on-line broker's system, the present invention enables entry of the instructions on the screen in a very fast, very easy and error-free way.

In the examples of embodiment of FIGS. 3 to 5, the investor can select the lot 21 of the individual securities 22 in the area 23. Each of the aforesaid securities 22 is followed, in the respective areas 24, by entry of the price at which the transaction is to be carried out (which may be an explicit numerical price or else a “parameter string” which denotes the market price, or a price that can be functionally derived in a predefined manner from the price data that arrive from the market in real time) and by the quantity of stock-exchange securities which can be entered in the area 25 as a predetermined amount.

Other data displayed refer to the quantities of securities on order (area 26) and to the amounts actually in the customer portfolio (area 26′), as well as to the different lists of preferred securities that may be selected (area 21) and to the command for sending the order (the purchase is effected by clicking on the soft key 27 corresponding to the security 22 that has been selected, whereas the sale is effected by pressing the corresponding soft key 28), whilst the additional areas 29 of the screen 20 are provided for display of other information that may be useful for the investor.

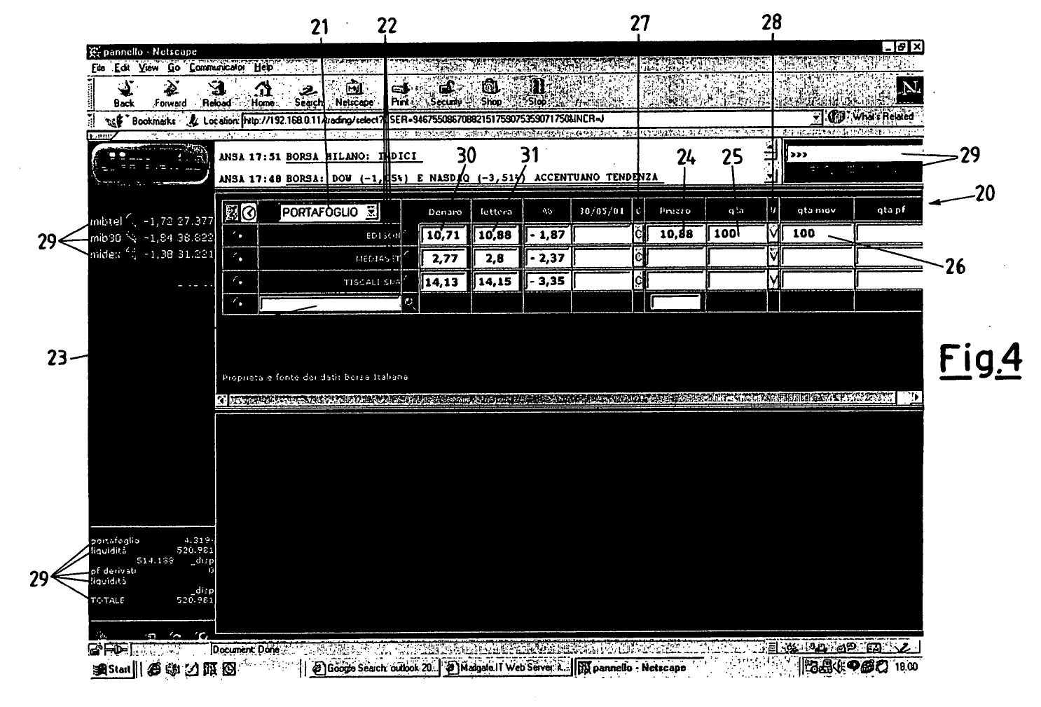

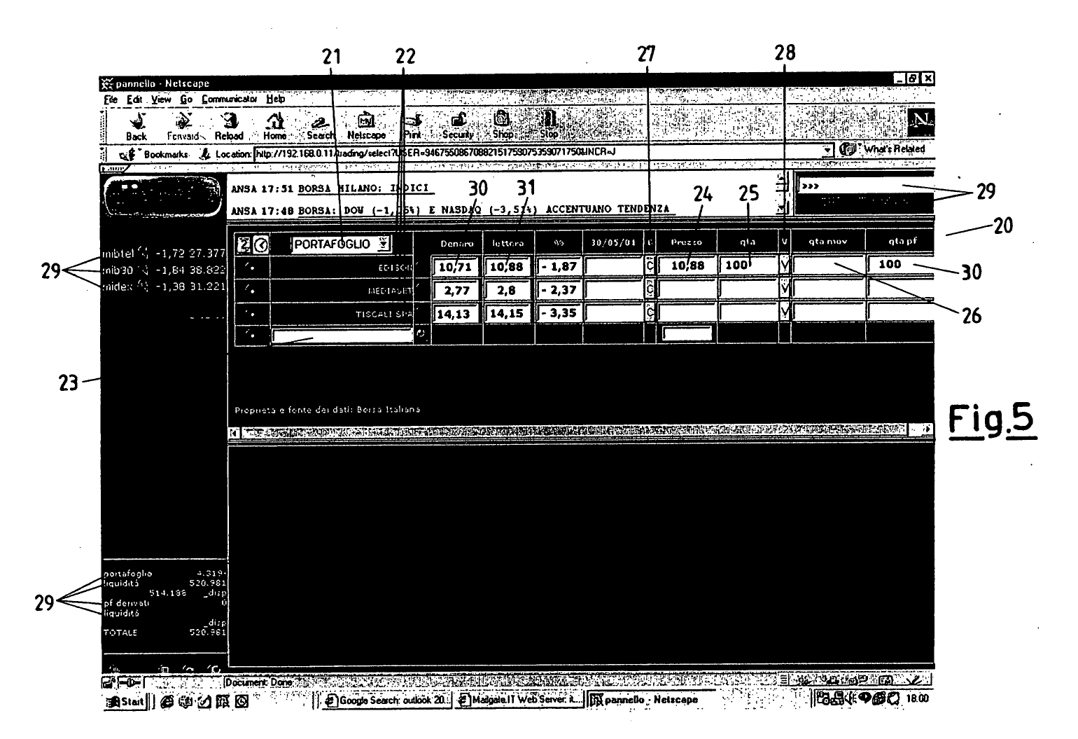

It may be noted how the amount of 100 (box 25) of FIG. 3, after the order (let us suppose a purchasing order) has been forwarded, appears, in FIG. 4, also in the forwarding box (box 26), and finally, once the execution has been obtained, the said quantity appears, in FIG. 5, in the portfolio box (box 30), which is designed to give, each time, the progressive amount of securities held by the investor.

In order to execute his transactions on stock-exchange securities, the investor can, for a set of preferred securities on which he intends to operate, pre-enter the necessary data and commands on the screen 20 by means of an appropriate combination of keyboard, and/or mouse, and/or pen and/or other device for interacting with the screen, so as to be ready, when the market conditions are appropriate, then to send the purchasing or sale orders on rapidly, with a single click for one or another of the securities, to the system of his on-line broker.

Consequently, in the first place, the present invention enables execution of financial transactions regarding a security or set of securities by means of a single click or, respectively, by a rapid succession of single clicks, one for each security, without any need, in the latter case, for recalling the individual order forms of each security one after the other. In normal window environments for PCs this would entail the need for two clicks instead of just one: the first click for activating the “order form” and the second click for actually sending the order.

Furthermore, thanks to the possibility of entering symbolic string commands (of the “current market price −3 ticks if sale, +3 ticks if purchase” type), the system that forms the subject of the present invention enables speeding-up of the preparation of the trading transaction and elimination of errors and difficulties deriving from frequent price changes.

In particular, for this purpose, the amounts are entered by the investor for each security 22 of the lot 21 in the box 25 of the respective security only upon execution of the first order, and for the price, where this is not typed in full into the field provided 24, the box is used for containing a “parameter string” capable of determining the price “symbolically”. For example, a “market price” order is sent if in the price box 29 a blank is indicated. If the character is “x”, the “money”) price is used (areas generically designated by 30 in FIGS. 3 to 5), or the “letter” price (areas generically designated by 31 in FIGS. 3 to 5) is used, respectively in the case of sale and purchase of the security. If the character is “x3”, the “money −3 ticks” price is used or else the “letter +3 ticks” price is used.

At this point, in order to send the order to the market, for all the orders after the first one, it will suffice to click on the “buy” key 27 or on the “sell” key 28; alternatively, it is possible to provide even just a single “buy and sell” key, which can switch its designation and its own function at each individual operation, alternating between the buy and the sell operations.

However, in order not to create additional errors and confusion of perception in the investor, it is preferable to use the trading system according to the invention, providing the distinction between a “buy” key 27 and a “sell” key 18 on the screen 20. This embodiment enables any typing errors to be avoided and presents the additional advantage of possibly enabling sending of a second order of the same sign (i.e., two consecutive purchasing or selling operations), instead of an order of opposite sign (i.e., a selling operation following upon the purchasing operation), a fact which may at times prove advantageous in the “scalping” technique.

FIGS. 3 to 5 are schematic representations of the modalities with which the present invention facilitates a faster and more efficient sending of orders to purchase stock-exchange securities via telematics.

The system according to the invention makes possible, for each security 22 chosen by the user, real-time reading of the quotation data present on the screen 20 and organization of the data according to a visually and ergonomically very compact and well-defined format, which enables the user both to decide whether to execute the transaction on line or to send orders of a number of securities to the on-line broker, using just a few clicks that are possible with a limited shifting of the cursor on the screen.

In this way, a series of orders for a set of securities can be sent in a simple and fast way without any errors or with only a tiny amount of errors and in restricted time intervals, so that the criteria or transactional instructions still prove valid.

Since the present invention enables an extensive prior arrangement of the parameters of security, price and quantity for an entire series of orders, and since it organizes the market data, the parameters of the individual orders and the “buy/sell” commands in a single, very compact, grid-type window, it makes possible well-informed and fast operations to be executed, with possible intervals between one operation and the next that are extremely short, in a way which a traditional operator is absolutely unable to perform, because the need, which is common to prior systems, for activating a separate window for each security order presents the dual disadvantage of using the space on the screen in a more disorderly, dispersive and geometrically less efficient way, and of normally requiring two clicks for sending an order (as already noted, one first click is required for activating the order window) instead of just one click.

From the foregoing description the characteristics of the system for trading in stock-exchange exchange securities via telematics with accelerated organization, which forms the subject of the present invention, emerge clearly, as likewise are clear the advantages afforded.

Finally, it is evident that numerous other variations can be made to the trading system in question, without thereby departing from the principles of novelty inherent in the inventive idea, just as it is evident that, in the practical embodiment of the invention, the functions, materials, forms and dimensions of the items illustrated may be any whatsoever according to the requirements, and the said items may be replaced with other technically equivalent ones.

1. A system for entering and sending orders for buying and selling stock-exchange securities via telematics with accelerated organization, the said system operating on remote user workstations equipped with keyboard and/or mouse and/or pen and/or other device for interacting with the screen, and being designed to have on the screen of the workstation a single window grid (20) capable of containing a number of securities and, for each security, the basic parameters of an order, namely amount, limit price, buy/sell parameter and “send order” soft key, the system being such as to enable selection of at least one security and transmission of the order thereof to means which execute the order of buying or selling said securities, and being characterized in that, once the order has been sent, the same area remains pre-arranged for the sending of other orders of the same type or ones of opposite sign.

2. The system for entering and sending orders for buying and selling stock-exchange securities via telematics with accelerated organization according to claim 1, which operates on remote user workstations equipped with keyboard and/or mouse and/or pen and/or other device for interacting with the screen, designed for receiving data from at least one financial market, the system being characterized in that, for at least one item of data, which has not been typed in fully in at least one given area of said screen (20) by a user, a value derived from the market data according to the value of a character-parameter string present within said area of the screen (20) is used.

3. The system for buying and selling stock-exchange securities via telematics with accelerated organization according to claim 1, characterized in that two soft keys (27, 28) are provided for sending the order to said market, the said soft keys being usable, respectively, for purchasing and selling one or more securities chosen by the user.

4. The system for buying and selling stock-exchange securities via telematics with accelerated organization according to claim 1, characterized in that a single soft key enables sending of said order, said soft key changing its designation and its function at each individual trading operation, alternating between purchase and sale.

5. The system for buying and selling stock-exchange securities via telematics with accelerated organization according to claim 1, characterized in that said data received from said market are displayed in real time, and in that said sets of data are selected and transmitted on the basis of at least one predetermined variable parameter.

6. The system for buying and selling stock-exchange securities via telematics with accelerated organization according to claim 1, characterized in that it comprises at least one graphic interface which interacts with said video terminal and is responsible for carrying out checks as regards the selection, formatting and transmission of said data.

7. The system for buying and selling stock-exchange securities via telematics with accelerated organization according to claim 6, characterized in that said graphic interface enables display of symbols, types, prices (24), amounts currently being executed (25), and amounts in portfolio (26) and offered (29, 30, 31) of said stock-exchange securities (22), which may possibly be grouped together in lists of favourites (21).

8. A method for buying and selling stock-exchange securities via telematics with accelerated organization, characterized in that it comprises the following steps:
receiving data on user workstations by central computers for managing orders for stock-exchange securities;
transferring said data onto a screen (20) of the user workstation;
selecting at least one set of data regarding a security identified in said screen (20):
transmitting said set of data thus processed to said central computer for managing orders of stock-exchange securities in order to carry out said trading operation; and
sending said order to a securities market, as likewise for all the orders after the first one, by selecting at least one pre-set soft key (27, 28).

9. The method for buying and selling stock-exchange securities via telematics with accelerated organization according to claim 8, characterized in that, for at least one item of data, which is not typed in fully by the user in a special field provided on said screen (20), at least one predetermined value from the flow of the quotations of the prices coming in real time from the market is used according to a parameter string indicated within said field.

10. The method for buying and selling stock-exchange securities via telematics with accelerated organization according to claim 8, characterized in that said order is sent by alternatively selecting a first “buy” soft key (27) or a second “sell” soft key (28) for trading in said stock-exchange securities.

11. The method for buying and selling stock-exchange securities via telematics with accelerated organization according to claim 8, characterized in that it further comprises the following steps:
processing the data received within said screen (20);
receiving in real time said data from said central information-management system; and
transmitting at least one set of data to said on-line broker's information system on the basis of at least one variable predetermined by a user;
said screen (20) including the representation of symbols, types (22), prices (24), amounts (25, 26) and further information (30, 31) on one or more stock-exchange securities (22), which may possibly be grouped together in lists of favourites (21); and
said steps, with the exception of the decision to transmit at least one set of data to the on-line broker, being performed automatically.

12. The system and method for buying and selling stock-exchange securities via telematics with accelerated organization, substantially as described and illustrated in the attached drawings and for the purposes specified herein.
